(19) United States
(12) Patent Application Publication
(10) Pub. No.: US 2013/0033121 A1
(43) Pub. Date: Feb. 7, 2013

(54) Personal grounding device or method to ground for a human being

(71) Applicant: Russell E. Simpson, ANDERSON, IN (US)

(72) Inventor: Russell E. Simpson, ANDERSON, IN (US)

(21) Appl. No.: 13/567,710

(22) Filed: Aug. 6, 2012

Related U.S. Application Data
(60) Provisional application No. 61/515,641, filed on Aug. 5, 2011.

(51) Int. Cl. H02H 99/00

(52) U.S. Cl. 307/326

(57) ABSTRACT

A personal grounding device that is used to ground a human being and provides a human being a device to directly and naturally equalize one's body to the same energy level, or potential, as the Earth. This equalization results in synchronizing the person's internal biological clocks, hormonal cycles, and physiological rhythms and in supplying the body with healing and free, positively charged electrons (called free radicals). These are abundantly present on the surface of the Earth. Electrically speaking free radicals have a positive charge. The grounding directly equalizes the body of the person to the same energy level, or potential (zero), as the Earth. The device is comprised of a closed grid (like a heating pad) in an encasement to form a mat; a lead to the grid from a ground; a ground lead (natural or artificial); and a means for connecting the field grid to the ground.

### CROSS-REFERENCE TO RELATED APPLICATIONS:

This application claims the benefit of Provisional Patent Application Ser. No. 61/515,641 filed Aug. 5, 2011, by Russell E. Simpson and entitled “A personal grounding device or method to ground for a human being”.

### FIELD OF INVENTION

This invention relates to a personal grounding device or method to ground for a human being. Particularly this device and method provides a human being a device and a way to directly and naturally equalize one's body to the same energy level, or potential, as the Earth. This equalization results in synchronizing the person's internal biological clocks, hormonal cycles, and physiological rhythms, and supplying the body of the person with healing, free of positively charged electrons (free radicals) that are abundantly present on the surface of the Earth. Electrically speaking free radicals have a positive charge. Free radicals also are constantly in search of ground to which they can discharge themselves and become neutral. What makes free radicals a concern and potential danger is that they may strip electrons from molecules in healthy tissue if necessary. But reconnecting to the Earth allows for the transfer of free electrons into the earth (ground) where they can be neutralized. This removes the positively charged free radicals that cause calamities such as tension, inflammation, anxiety and obesity. The end result, empirical observations and research show, is that grounding can prevent or reduce chronic inflammation. Hence, this grounding directly equalizes the body of the person to the same energy level, or potential (zero), as the Earth. This completes the natural flow of electricity.

The personal grounding device or method to ground for a human being works by induction and having an electrical conductor (looped into an electrical “field-like” configuration) being in close proximity/contiguous to a human or animal's body. This permits then the natural electro-magnetic forces discharge and flow to the ground of the earth's natural ground, hence helping to rebalance the human body with the natural zero electrical charge of the earth. This means that electricity stored and trapped in the human body dissipates through the field and removes the inherent charge and neutralizes the human system back to the level of the attached ground. The applications for these devices anticipate full original equipment devices or as aftermarket installation of a plug with various closed looped (fields) like heating pads (as discussed below).

### FEDERALLY SPONSORED RESEARCH

Not Applicable.

### SEQUENCE LISTING OR PROGRAM

Not Applicable.

### BACKGROUND—FIELD OF INVENTION and PRIOR ART

### Problem Addressed

The problem and purpose for a personal grounding device or the method for a human being (or animal) project is to provide a method/procedure to replace the physical contact with the Earth that has been lost since people no longer walk bare-footed. Also, people often use insulating materials for flooring and plastic plumbing (instead of grounded metal), effectively removing any circuitry that allows for a natural discharge of accumulated electrical exposure. Just as an electrical circuit must have a ground, so must the human body.

One could argue the importance of having an effective ground is even more so since the abundant presence of electrical power cords and electronic devices are in proximity to a person's body almost constantly. Power cords for 110 volt AC power radiate constantly electrical waves and persons who are close-by are subject to that radiation. However, people are more often than not insulated from any effective point of discharge (to Ground). Humans have constant exposure to measurable electrical radiation from: all power supply cords for household lighting and appliances remote control devices for lights, entertainment, garage door openers, computers, mobile phones, short-wave communication radios, other communication devices (Walkie-talkies, radios, televisions, microwave towers), etc. Beyond the home environment, people in manufacturing settings are often exposed to 220/440 volt and the additional ever-present radiation associated with such power transmissions.

### PRIOR ART

A novelty search was conducted for the personal grounding device or a method to ground a human being. As far as known, there are no personal grounding devices or methods to ground for a human being or the like with features shown herein. It is believed that this product is unique in its design and technologies. A U.S. Pat. No. 4,373,175 called an “Apparatus to dissipate static electricity” was issued to Mykkanen in 2008 that teaches a safety apparatus connectible between a human and an electrically conductive terminal includes an electrical part connectible to the terminal, a first electrical cable having one end adapted for electrical connection to the human, and an electromechanical device interconnecting the opposite end of the cable and the electrical part, such electromechanical device including releasably interconnected plug and socket elements and an elongated flexible connection located between the elements and part, the elements being releasable in response to tension exertion transmitted between the cable and the flexible connection. This wrist device was for static electricity and the pad device by Simpson is a device used when reclining for a total body grounding release. Another U.S. Pat. No. 4,450,498 was issued to Siegal in 1984 called an “Electrically grounded, static absorbing drapery installation”. Taught here is an electrically grounded, static absorbing drapery installation which employs a decorative conductive drapery fabric having dis-connectable electrical connector means installed thereon for connection to the ground terminal of a conventional wall outlet for dissipating accumulated static charge. The electrical connector means do not interfere with opening and closing of the drapery in its installed condition. Also the electrical connector means can be selectively disconnected to permit cleaning or repair of the drapery. This is for a room operation and not a personal grounding condition as shown by the Simpson application.

The next related U.S. Pat. No. 4,680,668 was issued to Belkin in 1987 and is called an “Anti-static device” This is a device for dissipating electrostatic electricity from a person wearing a static protecting garment. The device comprises a means for continuously conducting electricity between the garment and the person; and means for continuously conducting electricity from the garment and person to ground. The invention is also directed to a method of preventing electrostatic damage to a device which is sensitive to electrostatic potentials, said device being handled by a person wearing a static protective garment. The method comprises simultaneously and continuously grounding the person and the garment. The device is a static electricity discharge device and not suitable for grounding like the Simpson pad system. Next is the U.S. Pat. No. 5,448,840 that in 1995 was issued to Cheskin called a “Shoe containing electrically conductive integral elements”. This device shows a shoe for enhancing human physical performance by establishing an electrical conduit between the body and the ground is described. The shoe outsole is formed of a conductive rubber material. A resilient conductive element is integral with the outsole and extends along a portion of the outer surface of the shoe upper, typically being secured to and around at least a portion of the collar of the shoe and further extending over at least a portion of the inside surface of the upper. The device does not accomplish or provide a pad system for the human body to release in a relining position.

More recently, U.S. Pat. No. 6,683,779 by Ober was issued in 2004 and called a “Personal body grounding system”. This shows a personal grounding system for collecting and removing unnatural electrical charges from a human body includes a grounding pad having a layer of carbon fibers, and a conductor substantially extending across the layer in conductive contact with the carbon fibers. A ground lead is conductively coupled to the grounding pad conductor at one end thereof and conductively coupled to a grounded anchor at a second end thereof. Preferably, the grounded anchor is placed directly into the earth, although in certain applications constitutes a metal grounding component. The system may include a wall plate in conductive connection with the grounded anchor. The ground lead is removably attached to the wall plate via a connector attached thereto. The grounding pad may be configured to be a sleeping pad, seat pad, or strap or patch attachable to the human body. This device is more complex, connects to a special ground rod and is considerably larger than the simple Simpson pad. Finally, U.S. Pat. No. 7,349,194 issued in 2008 to Elliot is called a “Method and system for electrically connecting the human (and vertebrate) organism to earth so as to facilitate a current flow between the human biopotential and earth for the purpose of promoting health, well being, and performance”. This demonstrated a method and system for providing an electrical connection between the human and earth ground for purposes of promoting health, well being, and performance. It is based on the premise that vertebrate organisms require electrical connectivity to earth for health and well being, especially during times of trauma. It is asserted that vertebrate bio-potential may be modulated by varying the resistance from the body to earth ground and that via this mechanism, bioenergy production and internal impedance may be modulated for purposes of healing, health maintenance, and “work” including exercise. Instructive methods for characterizing an individual's bio-potential and for applying the present invention in urgent portable medical care situations are provided. This patent is unlike Simpson in that it requires a ground rod and appears capacitive rather than the Simpson inductive system.

### SUMMARY OF THE INVENTION

This invention is a personal grounding device or method to ground for a human being. The technology taught here are the ways a personal grounding device or method to ground for a human being may be simply attained with an electric field and a connection to an electrical ground. An alternative embodiment is a simple adapter that may be used with an existing coil such as a heating pad or the like. This may be as a full and complete original equipment appliance or as an add-on plug sold and used with existing coils (heating pads). The new device is much less costly, more portable, and a smaller, compact size as compared to other grounding (or sometimes called earthing in the United Kingdom) devices in the market place.

The preferred embodiment of the personal grounding device or method to ground for a human being is comprised of a field or closed grid (like a heating pad); a lead; a control means (option) to the coil; a ground lead (natural or artificial) and a means for connecting the field grid to the ground. An alternative of the device is a plug only with a special configuration which permits a commercially available field grid (such as a heating pad) to connect to a ground and other features to secure the device mechanically while assuring no power conduction to the grid field.

The newly invented personal grounding device or method to ground for a human being may be manufactured at low volumes by very simple means and in high volume production by more complex and controlled systems.

### OBJECTIVES AND ADVANTAGES

There are several objectives and advantages of the personal grounding device or method to ground for a human being. There are currently no known personal grounding devices that are effective at providing the objectives of this invention.

In the health and personal well-being of a person, the overall effects of exposure to the electrical radiation and energy is really an unknown field. However, empirical tests with grounding mats and grounding straps show significant improvements to the person if a grounding device or method is regularly utilized. The uses shown below in the operations section find empirical proof of reduced joint and muscle inflammation and aches, reduced stress, and even some gradual and controlled weight loss. These will be discussed below. As important as the results to the human are the manner and objectives one might expect from introducing such technology to the public for improved health and well-being. The personal grounding device or method to ground for a human being expects to meet several immediate objectives.

These include:

| Item | Objective |
|---|---|
| 1 | Market to elderly, athletic oriented, middle and |
| | young stressed managers, and infirm persons |
| 2 | Lead with Low entry level pricing |
| 3 | Provide Trickle grounding (not sudden impact to |
| | body) so that it mimics a slow natural process |
| 4 | Provide a compact and portable device |
| 5 | May use existing processes and manufacturing |
| | equipment so that there are relatively low start-up |
| | costs to manufacture |
| 6 | Can be self a contained system or an add-on plug for |
| | use with electrical pads (such as a heating pad or |
| | the like) |

Finally, other advantages and additional features of the present personal grounding device or method to ground for a human will be more apparent from the accompanying drawings and from the full description of the device. For one skilled in the art of improved health and well-being devices and methods, it is readily understood that the features shown in the examples with this product are readily adapted to other types of grounding systems and devices for humans.

### DESCRIPTION OF THE DRAWINGS—FIGURES

The accompanying drawings, which are incorporated in and constitute a part of this specification, illustrate an embodiment of the personal grounding device or method to ground for a human being that is preferred. The drawings together with the summary description given above and a detailed description given below serve to explain the principles of the personal grounding device. It is understood, however, that the personal grounding device or method to ground for a human being is not limited to only the precise arrangements and instrumentalities shown.

FIGS. 1 A through 1 C are sketches of a personal grounding device for a human being and the auxiliary plug for the device.

FIGS. 2 B through 2 D are sketches of the prototype for the personal grounding device to ground a human being with components and features noted. FIG. 2 A is a sketch of the device with components and features noted. FIG. 2 E is a sketch of a common heating pad adapted to be used as a grounding device with the addition of the special ground plug.

FIGS. 3 A through 3 C are sketches of an alternative prototype sample with the components and features shown from generally a side view. FIG. 3 D are reference plugs for use with the device.

FIGS. 4 A through 4 E are sketches of a sample of the auxiliary plug for the device with the components and features shown from generally a side and end view of the section.

FIGS. 5 A and 5 B are reference plastic safety plugs with spade plastic blades. FIG. 5 C is a typical American main plug/receptacle with features noted.

FIGS. 6 A through 6 D are prior art devices in the grounding technology.

FIGS. 7 A through 7 C sketches for the addendum explanation of grounding devices.

### DESCRIPTION OF THE DRAWINGS—REFERENCE NUMERALS

The following list refers to the drawings:

| Ref # | Description |
|---|---|
| 30 | General personal grounding device |
| 30A | Prototype sample of General personal grounding device |
| 33 | Wiring grid/field - copper, aluminum, carbon cords, conductive |
| | composite or the like) |
| 35 | Surface/cover to device (conductive, non-insulated) |
| 40 | Power lead (from ground field to ground connection) |
| 41 | Means for controlling resistance/power transfer of a heating pad |
| 50 | Auxiliary grounding plug |
| 50a, b, c | Alternative Auxiliary grounding plugs |
| 50D | Optional Ground stud/extension with plastic stabilizer straight |
| | blades - 54NC and 55 NC |
| 51 | Ground stud/extension |
| 51A | Two prong cable ending - live and neutral |
| 51R | Ground receiver |
| 54 | Power (short) blade conductor |
| 54R | Power (short) receiver |
| 54NC | Non-conductive short blade |
| 55 | Neutral (long) blade conductor |
| 55R | Neutral (long) receiver |
| 55NC | Non-conductive (long) blade |
| 56 | Common duplex grounded receptacle |
| 57 | Home ground pole or rod (copper or equal pole driven and ground |
| | lead conductively clamped to pole/rod) |
| 58 | Exterior of ground plug |
| 59 | Extended cable/cord to a ground point (such as item 57) and the |
| | secure connection (such as a clamp) between the extended cable |
| | and the ground rod |
| 60 | Plastic safety plug with plastic blades |
| 61 | Ground - natural or commercial with sunk lead into earth |
| 62 | Plastic blades to mechanically enhance security to plug but |
| | assure non-conductivity |
| 70 | Prior Art U.S. Pat. No. 6,683,779 |
| 71 | Prior Art US Publication 2002/0027761 |
| 80 | Method for personal grounding |

### DETAILED DESCRIPTION OF PERFERRED EMBODIMENT

The present development is a personal grounding device or method to ground for a human being. Particularly this product is related to personal grounding devices or methods to ground a human being. This invention as a grounding device or method may be simply attained with an electric field and a connection to an electrical ground. An alternative embodiment is a simple adapter that may be used with an existing coil such as a heating pad or the like.

Taught here is a personal grounding device or method to ground a human being from electrical field being close to a body and then the natural electro-magnetic forces discharge and flow to ground of the earth's natural ground, hence helping to rebalance the human body with the nature surrounding the body. This means that electricity stored and trapped in the human body dissipates through the field and removes the inherent charge and neutralizes the human system back to the level of the attached ground.

The advantages for the a personal grounding device used to ground for a human being 30 are listed above in the introduction. Succinctly the benefits are that with the device one may:
Market to elderly, athletic oriented, middle and young stressed managers, and infirm persons
Lead with Low entry level pricing
Provide Trickle grounding (not sudden impact to body) so that it mimics a slow natural process
Have and provide a compact and portable device
May use existing process and manufacturing equipment so that there are relatively low start-up costs to manufacture
Can be self a contained system or an add-on plug for use with electrical pads(such as a heating pad or the like)

The preferred embodiment of the personal grounding device 30 or method 80 to ground for a human being is comprised of a field or closed grid 33 (like a heating pad); a lead 40; a ground lead 57 (natural or artificial) and a means 59 for connecting the field grid to the ground 57. An alternative of the device is a plug 50 only with a special configuration which permits a commercially available field grid (such as a heating pad) to connect to a ground and other features to secure the device mechanically while assuring no power conduction to the grid field. This alternative is a personal grounding device to ground a human being with a body and a charged state of electrons, the device is comprised of an adapter with a receiving end that is comprised of a recessed slot for a short power blade, a recessed slot for a long blade, and an aperture for a long neutral blade, the said recesses and aperture all enclosed by a body and the neutral aperture ending at an opposite engaging end that has a means for connecting to a ground stud wherein an existing mat with an electrical cord may be placed under a part of the human's body for a period of time to ground the electrical imbalance between the person's body and the earth's natural state of no charge and the cord may be connected to an electrical neutral with the adapter.

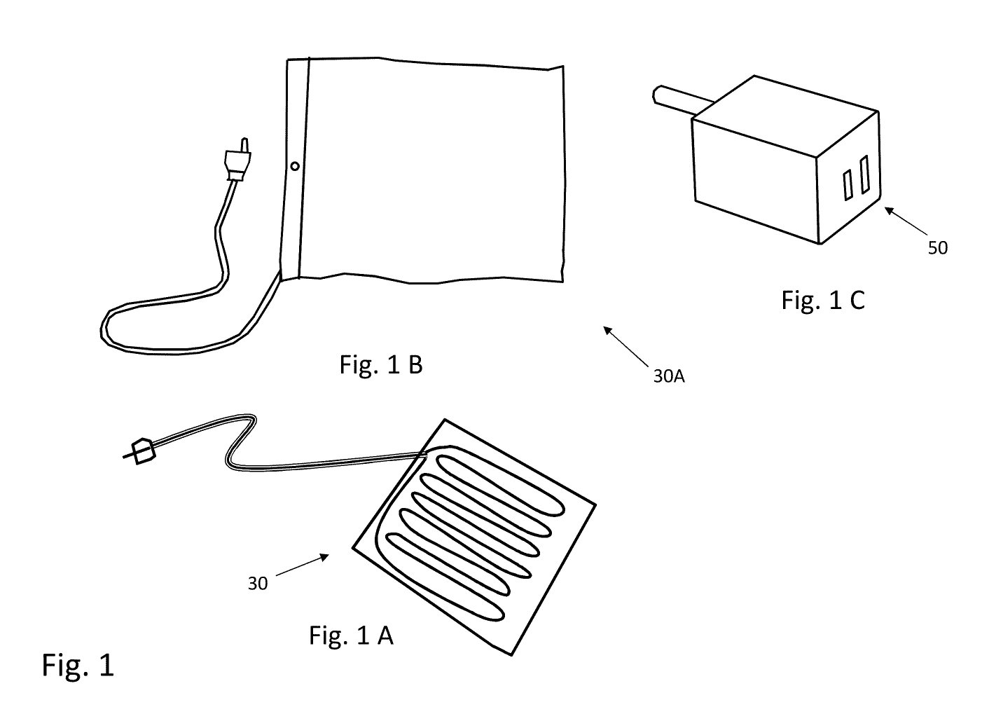

There is shown in FIGS. 1-7 a complete description and operative embodiment of the personal grounding device or method to ground for a human. In the drawings and illustrations, one notes well that the FIGS. 1-7 demonstrate the general configuration and use of this product and related items. The various example uses are in the operation and use section, below.

The accompanying drawings, which are incorporated in and constitute a part of this specification, illustrate an embodiment of the personal grounding device 30 or method 80 to ground for a human being that is preferred. The drawings together with the summary description given above and a detailed description given below serve to explain the principles of the Special grounding apparatus for humans 30. It is understood, however, that the grounding device 30 is not limited to only the precise arrangements and instrumentalities shown. Other examples of a personal grounding device or method to ground for a human being and uses are still understood by one skilled in the art of electrical grounding mat devices for human beings to be within the scope and spirit shown here.

FIGS. 1 A through 1 C are sketches of a personal grounding device 30 to ground for a human being, a prototype 30A and the auxiliary plug 50 for the device.

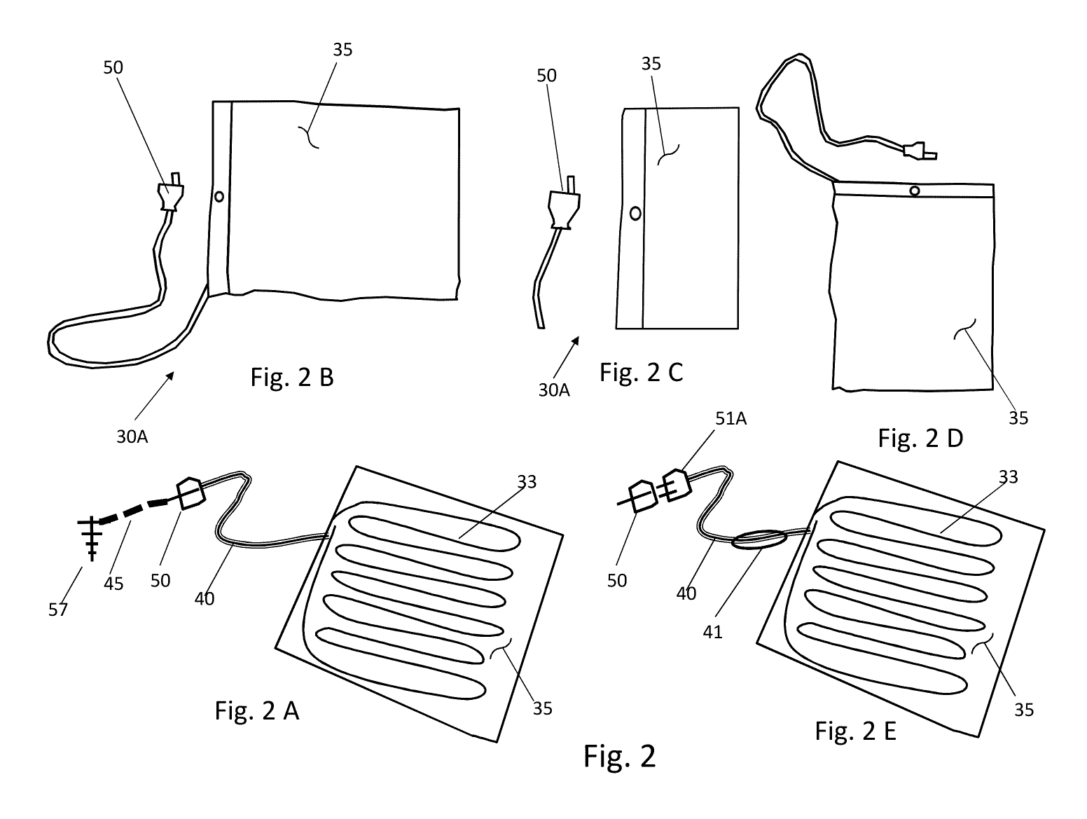

FIGS. 2 B through 2 D are sketches of the prototype 30A for the personal grounding device to ground a human being with components and features noted. Shown in FIGS. 2 B through 2 D are the prototype 30A with the surface 35 containing the (hidden) winding field 33. The cover 35 should be an inductive permitting, conductive, non-insulating material such as a cloth or simple cotton container or non-insulating vinyl, plastic or composite materials. Insulating plastics, vinyl and nylon may be used but may decrease the radiation of the electrons from the body to the field 33. In addition, the optional means for controlling (controller) 41, the power lead 40 and the plug 50 are shown. The conductive leads are connected to each end of the field 33 so that a closed loop is created. The wires or conductors for the field 33 anticipate copper, aluminum, carbon or a conductive composite material. FIG. 2 A is a sketch of the device 30 with components and features noted above. Also is shown the extended conductor and clamp means 45 from the ground plug 50 to the ground rod 57. FIG. 2 E is a sketch of a common heating pad with a controller 41 adapted to be used as a grounding device with the addition of the two prong plug 51A fit directly into the single prong ground plug 50 ground plug.

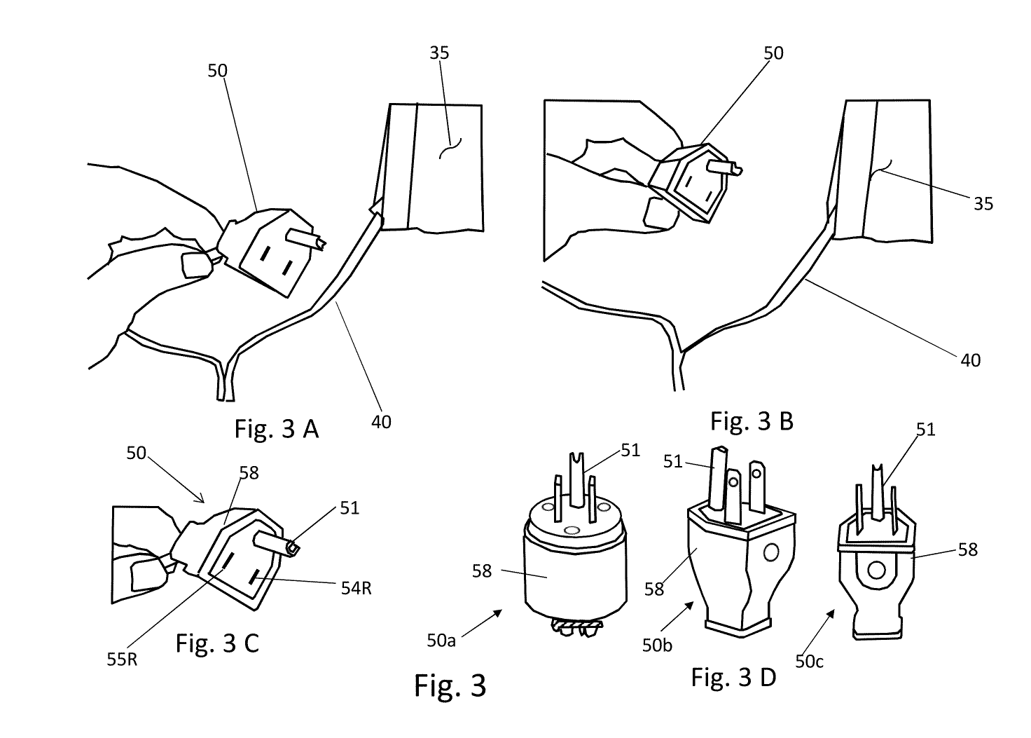

FIGS. 3 A through 3 C are sketches of an alternative prototype sample 50 with the components cover 35 and lead 40 and other features shown from generally a side view. FIG. 3 D are alternative reference plugs 50A, 50B, and 50C for use with the device 30. This shows that the configuration of the ground plug 50 may take the form of other generally available three-pronged plugs and remain in the scope and function of the device 30, 50.

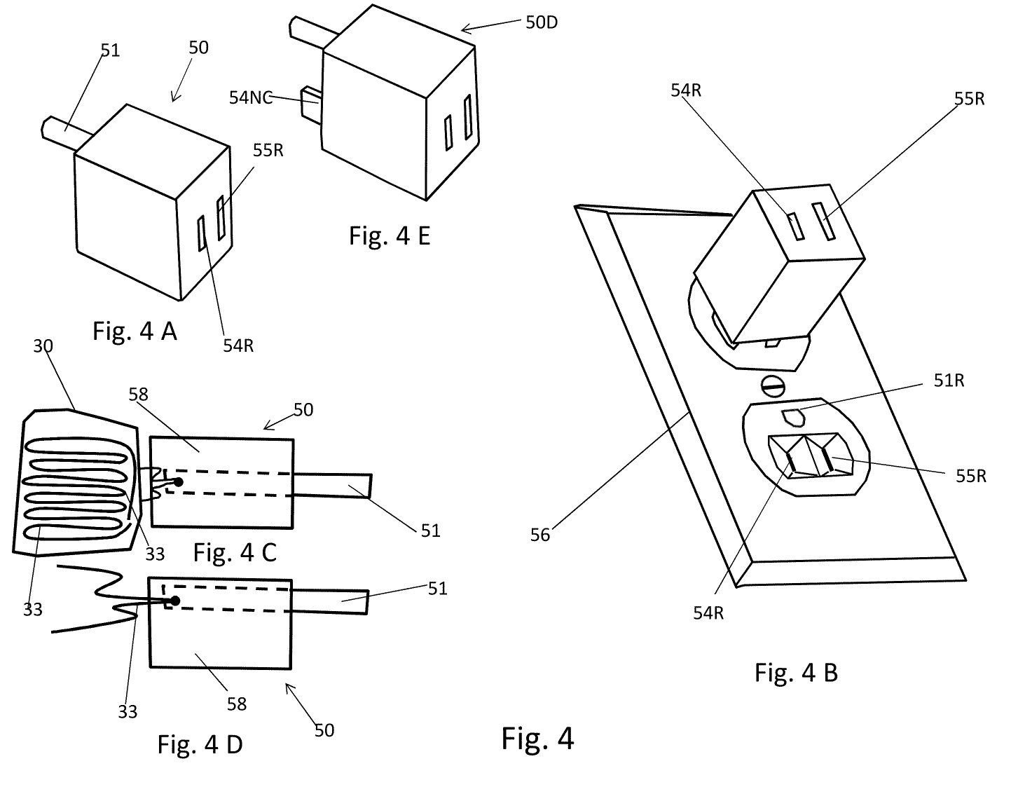

FIGS. 4 A through 4 B are sketches of a samples of the auxiliary plug 50 for the device with the components and features shown from generally a side and end view of the section. The recessed slots 54 (for the short power blade) and the long 55 (for the neutral blade) connect through the body 58 and engage the ground with the ground stud 51. So this is essentially a plug or adapter device with a receiving end that is comprised of a recessed slot for a short power blade, a recessed slot for a long blade, and an aperture for a long neutral blade, the said recesses and aperture all enclosed by a body and the neutral aperture ending at an opposite engaging end that has a means for connecting to a ground stud. Also shown are the plug device 50 connected to a recessed slotted receptacle 56 by means of the elongated ground 51 in FIG. 4 B. In FIGS. 4 C and 4 D are shown the plug end 50 secured to the field 33 interior to the surface 35 of the full device 30. FIG. 4 E is an optional ground plug 50D. Shown as an alternative are the non-conductive long 55NC and short 54NC spade blades that may afford even more mechanical security than a single ground 51.

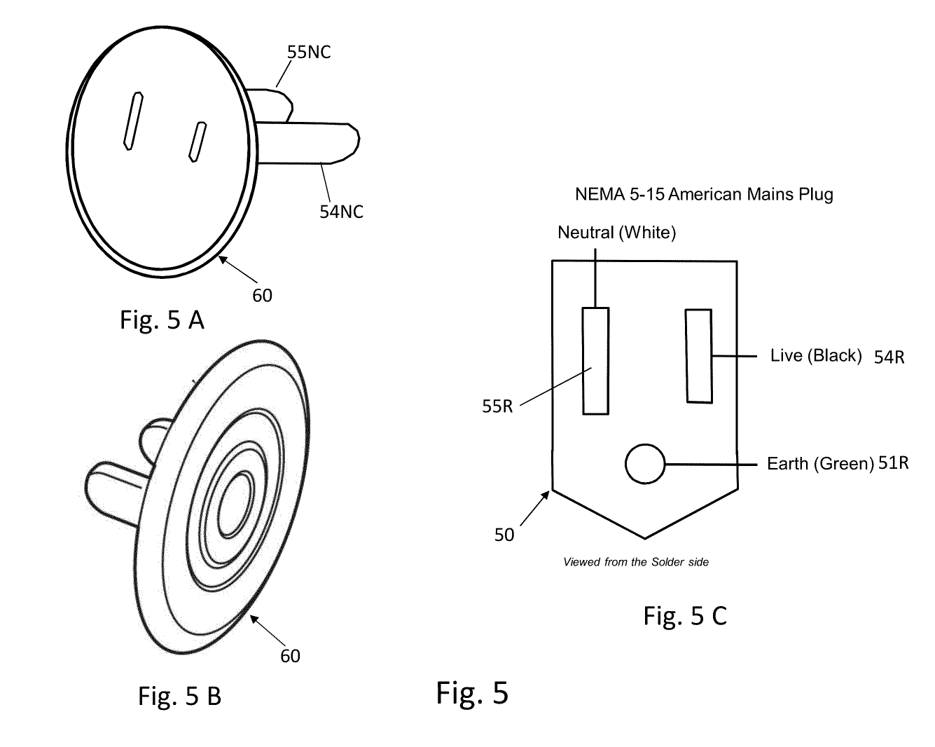

FIGS. 5 A and 5 B are reference plastic safety plugs 60 with spade plastic blades 54NC, 55NC. FIG. 5 C is a typical American main plug/receptacle with features noted. The plug has two flat parallel pins and a round ground or earthing pin. It is normally rated at 15 amperes and 125 volts maximum. The American standard for this connector is known as NEMA 5-15, and the Canadian standard CSA 22.2, No 42. The American and Canadian connectors are effectively identical. The ground pin is longer than the two parallel pins so that the device is grounded before the supply is connected. The neutral insertion point in the neutral socket is wider to accommodate polarized plugs, but non-polarized plugs often have both pins narrow, the ground pin thus enforcing polarity. With American and Canadian plugs, if a person looks directly at a socket, the ground socket will be at a bottom, the live slot is on the right and the neutral slot is on the left. If the plug is polarized, the widest slot is the neutral connector.

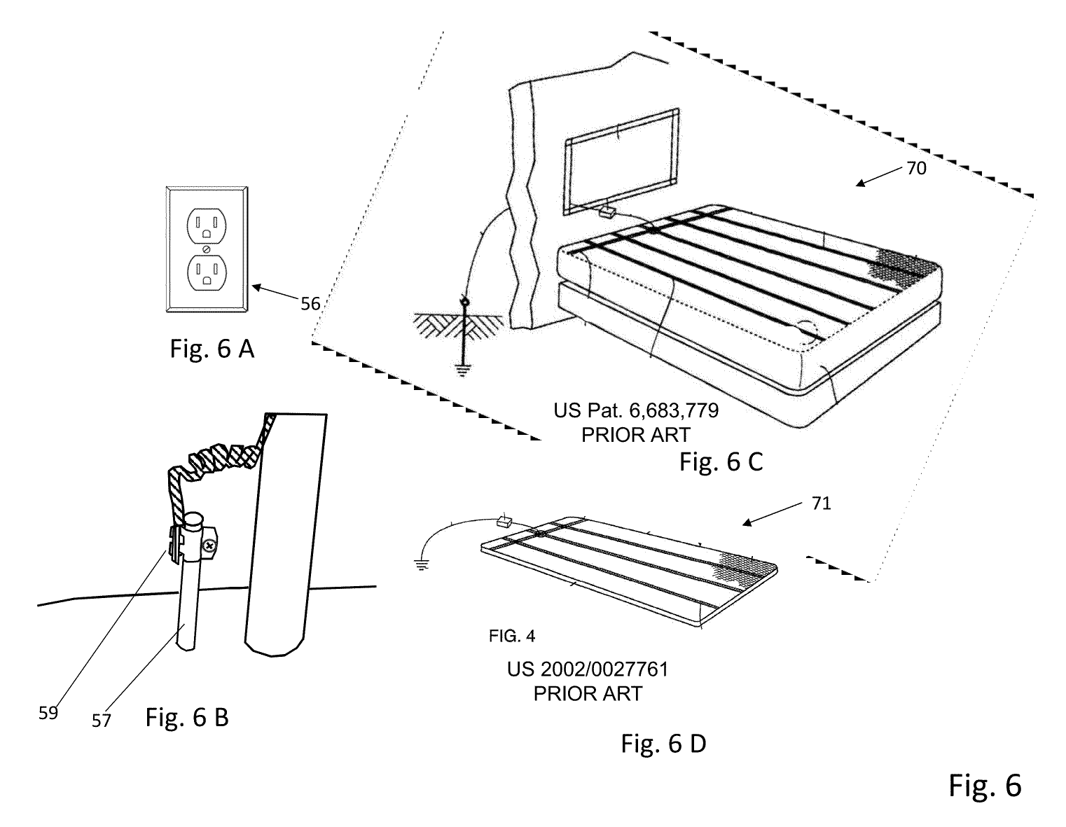

FIGS. 6 A through 6 D are prior art devices in the grounding technology. Sketch 70 is from the U.S. Pat. No. 6,683,779 and the sketch 71 is from the US application and the publication 2002/0027761 which later became U.S. Pat. No. 6,683,779. The FIG. 6 A shows a typical electrical duplex receptacle 56 with a ground. FIG. 6 B shows a typical ground rod 57 and connecting clamp and lead 59.

The details mentioned here are exemplary and not limiting. Other specific components and manners specific to describing a personal grounding device 30 or method 80 to ground for a human being may be added as a person having ordinary skill in the field of electrical grounding devices and mat devices and their uses well appreciates.

### OPERATION OF THE PREFERRED EMBODIMENT

The personal grounding device 30 or method 80 to ground for a human being has been described in the above embodiment. The manner of how the device operates is described below. One notes well that the description above and the operation described here must be taken together to fully illustrate the concept of the Special grounding apparatus for humans. The preferred embodiment of the personal grounding device 30 for a human being is comprised of a field or closed grid 33 (like a heating pad); a lead 40; a control means 41 (option) to the coil; a ground lead 57 (natural or artificial) and a means 59 for connecting the field grid to the ground. An alternative of the device is a plug 50 only with a special configuration which permits a commercially available field grid (such as a heating pad) to connect to a ground and other features to secure the device mechanically while assuring no power conduction to the grid field.

The personal grounding device or method to ground for a human being 30 operates somewhat similar to a conventional heating pad device except the device has no power attached. The end plug 50 is connected to a ground 57 through a lead 59. The pad is laid under ones back, legs, arms and contiguous to the person's surface of their skin. The field or excess electrons then emanate/radiate to the pad coils 33 and flow through the lead 40 to the plug 50 and ultimately to the ground 57. For convenience, the plug alone 50 may adapt to a standard heating pad which is turned off and only connected via the ground stud. As a precaution, the ground plug 50 is outfitted with ABS/plastic spades to assure no electricity or heat (from resistance of electricity flowing through the coil 33) is present.

Places where the device may be used. For an example and not as a limitation, the Special grounding apparatus 30 for humans may be used as follows:

| ITEM | DESCRIPTION of Places where the device may be Used |
|---|---|
| | At home |
| 1 | At the Dining table (wired padded seats or mats) |
| 2 | Family room seating, floor rugs |
| 3 | Any seating/lounging in the leisure areas |
| 4 | Any place the family would be sock-footed/bare- |
| | footed |
| 5 | In the Bathroom (with Positive identification of |
| | the ground receptacle) |
| 6 | Bath tub or shower mat |
| 7 | Throw-rug at the lavatory |
| 8 | AT TRAUMA SITES - Auto accidents, fires, violence, |
| | war battles for pain relief in any area of the body |
| 9 | AT ARREST SITES AND CONFINEMENT FACILITIES - |
| | A sleeping bag or body bag fashioned this way would, |
| | in a short time, reduce agitation and aggressive |
| | behavior |

There are several marketing themes to release the device into the market place. For example and not as a limitation, the following themes are under consideration:

### Marketing Themes

| Item | Description of Theme |
|---|---|
| 1 | Grounded! |
| 2 | Tension Funnel, Tension Drain, Anxiety Drain |
| 3 | Electric Drain, Obesity Drain |
| 4 | Relax and Lose (Weight) |
| 5 | Spark Arrester, Spark Neutralizer |
| 6 | Second Nature Grounding, Inside Grounding |
| 7 | Healthy Discharge, Natural Discharge |
| 8 | Home Weight Reduction (Made Easy) |
| | Now Achievable-While one rests |
| 9 | Hyper-tension: Relaxer - Ender - Release |
| 10 | Hyper-No More |
| 11 | Zero Static Electricity |
| 12 | Natural Weight Reduction |
| 13 | |

Other anticipated benefits include:

| Item | Potential Benefit |
|---|---|
| 1 | Eases joint pain and stiffness |
| 2 | Relieves anxiety and promotes relaxation |
| 3 | Improves muscle tone and skin quality |
| 4 | Bums calories and controls weight |
| 5 | Increases blood Circulation |
| 6 | Reduces inflammation |
| 7 | Improves cardiovascular health |
| 8 | Reduces stress and fatigue |

Method 80 of how to steps includes the following:

| STEP | DESCRIPTION |
|---|---|
| 1 | PROVIDE A CLOSED FIELD COIL MADE OF A CONDUCTIVE |
| | WIRES INSIDE A DURABLE ENCASEMENT |
| 2 | CONNECT COIL TO GROUND THROUGH A LEAD AND PLUG |
| 3 | PLACE COIL UNDER A PORTION OF A HUMAN'S BODY |
| | THAT NEED GROUNDING - SUCH AS THE BACK, FEET, |
| | LEGS, NECK, ETC |
| 4 | MAINTAIN THE COIL UNDER THE PLACE FOR A |
| | SPECIFIC TIME (SHORT PERIODS LIKE 15 MINUTES UP TO |
| | OVERNIGHT DURING SLEEP PERIODS) |
| 5 | REPEAT PROCESS DAILY |

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

With this description it is to be understood that the a personal grounding device 30 or method 80 to ground for a human being is not to be limited to only the disclosed embodiment of product. The features of the device and method are intended to cover various modifications and equivalent arrangements included within the spirit and scope of the description.

### Addendum:

The following addendum is fully incorporated into the specification as shown above. The descriptions and background is added for further clarification to the overall specification and subject matter presented herein.

The belief is when two objects come in contact with each other, the triboelectric action between them can generate an electrical energy charge that initiates an electro static discharge (ESD) event. The sudden release of generated charge in an object or person can produce extremely high voltages, currents, and electromagnetic fields that can result in malfunctioning, altering of device parameters, or even destruction of silicon junctions. In an ESD event, the human body can reportedly generate static charge levels as high as 15,000 volts by simply walking across a carpeted floor and 5,000 volts by walking across a linoleum floor. The potential difference between a charged human body and an object retaining an insignificant charge can range from a few hundred volts to as high as 30,000 volts.

From cell phones and computers to fluorescent lights and ambient house and high rise fields, human and other animal's brains, nervous systems and vital organs are constantly bombarded by voltage-induced inflammatory stresses undreamed of by any preindustrial ancestors. It is no accident that, one by one, virtually all of the major contemporary pathological profiles reveal a core of chronic inflammation in the human system—cardiovascular disease, cancer, auto-immune disorders, arthritis, fibromyalgia and innumerable others—the first two accounting for over 90% of humanity's sufferings. In its desperate attempt to meet this virtual epidemic the mainstream medical system has zeroed in on NSAID's—non-steroidal anti-inflammatory drugs—such as aspirin, ibuprofen and naproxen. Yet, at the same time, yearly deaths from prescription-drug intake have topped 100,000, making the pharmaceutical solution risky to say the least, and often prohibitively expensive. Meanwhile, in the world of alternative health and medicine, the focus has veered sharply in the direction of supplements, herbs and phytonutrients with potent anti-inflammatory capacities, such as quercetin, circumin and resveratrol, costly investments all, to be sure.

When direct or conductive contact is made with the surface of the earth, there begins an immediate discharge of positively charged, electron-seeking free radicals, which are quickly neutralized or “quenched” by the inflow of negatively polarized electrons. Lest we be tempted to think this is all so much New Age nonsense, it should be noted that the human system is a bio-dynamic electrical matrix, whose cardiovascular, neurological, immune and muscular systems—just to name a few—are catalyzed and regulated by micro-electrical currents at the cellular level, and that those cells each have their own unique frequency ranges. Just as with delicate electrical components in industry, the human system works poorly or not at all when there is an accumulation of static electricity or excessive voltage in its supersensitive bio-electrical grid. This is why industrial technologies always take care to ground such systems, enabling their impulses to flow undisturbed and undistorted.

Health field professionals report in some research, all the foods and holistic technologies reviewed, it looks like the biggest culprit of inflammation of auto-immune disorders—the most destructive invention in the history of humankind is the common shoe. Recent scientific innovations have discovered that the rubber sole completely blocks all the free electrons that shield and nourish the entire earth. When one steps outside barefoot, especially when he steps onto stone, he is encompassed at the speed of light with free electrons that the earth just gives him—all day, every day—all night, every night—forever. As soon as he puts his shoe on, it's gone—totally gone. He is insulated. Recent scientific advances have discovered the following—that circadian rhythm problems, hormonal disorders, cortisol disorders, heart rate variability problems are all related to wearing shoes. This means the arthritis, the inflammation, the herpes, the hepatitis, the autoimmune conditions are directly related to wearing shoes. This may be the most destructive device ever created by humankind.

How “Earthing” aka—also known as—Grounding Works—Electrically speaking, electrons have a negative charge, while free radicals have a positive charge. Free radicals also are constantly in search of negatively charged electrons to which they can attach themselves. What makes free radicals dangerous is that they will strip electrons from molecules in healthy tissue if necessary. But reconnecting to the Earth allows for the transfer of free electrons into the body where they can neutralize the positively charged free radicals that cause inflammation. The end result, as observations and research shows, is that Earthing can prevent or reduce chronic inflammation. This is exceptional news for those with cardiovascular concerns who need to keep inflammation in check in order to prevent further arterial damage. It's also good news for people who regularly deal with pain (which is often accompanied or aggravated by inflammation), or are looking for a speedier recovery from injuries. Partially repeated from Earthing: the Most Important Health Discovery Ever?

Throughout time, humans have strolled, sat, stood, and slept on the ground—the skin of their bodies touching the skin of the Earth—oblivious to the fact that such physical contact transfers natural electrical energy to the body. The theory is that Modern lifestyle has disconnected us from the Earth's energy, making humans more vulnerable to stress and illness. Earthing is the landmark discovery that this energy upholds the electrical stability of ones bodies and serves as a foundation for vitality and health. In an age of rampant chronic disease, reconnecting with the Earth's energy beneath people's very feet provides a way back to better health. They are, in essence, bioelectrical beings living on an electrical planet.

The surface of the Earth resonates with natural, subtle energies. Ongoing scientific research is discovering the details as to why people feel significantly better when they connect with these omnipresent energy fields. Earthing refers to the process of connecting by walking barefoot outside, as humans have done throughout history, or sitting, working, or sleeping grounded indoors. For more than a decade, thousands of people around the world—men, women, children, and athletes—have incorporated Earthing into their daily routines and report that they sleep better, have less pain and stress, and faster recovery from trauma. Earthing immediately equalizes one's body to the same energy level, or potential, as the Earth. This results in synchronizing a person's internal biological clocks, hormonal cycles, and physiological rhythms, and suffusing his body with healing, negatively charged free electrons abundantly present on the surface of the Earth.

Testing has confirmed that reduction of inflammation appears to be consistent with grounding. It has been observed that the larger the grounding device the more rapid the results and the more that sleep is improved.

In summary, 1) the bigger the ground plane the better, 2) direct skin contact with the Earthing device is essential, 3) any ground is better than no ground—the body always equalizes with the Earth's direct current (DC) and becomes charged with free electrons which we know reduces inflammation. In general, it is felt that all the systems work effectively to put one in contact with the Earth's natural energy.

Why does the Earth's electric field transfer so easily to the body?

A. The body is mostly water and minerals. It is a good conductor of electricity (electrons). The free electrons on the surface of the Earth are easily transferred to the human body as long as there is direct contact. Unfortunately, synthetically-soled shoes act as insulators so that even when one is outside, he does not connect with the Earth's electric field. When one is in a home and office building, he is also insulated and unable to receive the Earth's balancing energies.

What is the difference between the Earth's electric field and the electric field used to conduct electricity in ones home?

A. The Earth's electric field is mainly a continuous direct current (DC) producing field. Throughout history, life on the planet has attuned a human's biology to this subtle field. By comparison, home wiring systems in the U.S. use 60-cycle per second alternating current (AC). Unless at very low frequency (less that 10 cycles per second) and/or low power, alternating current is foreign to the person's biology. AC, and other forms of man-made environmental electromagnetic fields (EMFs) are being researched as possible factors in a variety of stress-related responses. Many people are sensitive to EMFs. Studies show an “association,” but not cause and effect, between living near power lines (or exposure to EMFs on the job) and higher rates of health problems.

How much “current” is actually being transferred from the Earth's surface via the wire to a grounding product?

A. There is no constant measurable current flow beyond the equalization charge that is instantly transferred to the body when a person lies on a conductive sheet or makes contact with another type of Earthing product. Here one is talking about numbers of electrons in the trillions and quadrillions. Once the body is grounded, the rate of influx changes, and the body will only absorb that amount of electrons needed to maintain the same electrical potential as the Earth and to restore what is lost in the body's metabolic processes. It may take many quadrillions to get the body stable. As long as a person continues to be grounded, the body can use the Earth as a natural reservoir, or “power source,” of electrons to maintain a “topped up” homeostatic level that compensates for any attrition of internal electrons. With connection to the Earth, it would thus seem hard for the body to develop any electron deficiency, and, theoretically, any chronic inflammation. The actual amount of charge (electrons transferred) would vary significantly based upon location of the body above the Earth (voltage) and any potential electrostatic charge that has built up on the body. The continuing amount of electrons absorbed by the body to reduce metabolic and immune response free radicals would also vary significantly between people depending upon their life style and activity. This is all extremely difficult, if not impossible, to measure.

If one does not live in North America. Can he plug his Earthing product into a wall outlet?

A. For using Earthing products around the world, there are some basic facts needed to determine the best connecting options. Earthing products are designed to be used with an Earthing ground rod placed in the soil outside next to a window or door, or via a grounded wall outlet inside the home or office. Individual conditions in ones home, office, and country may dictate which of these options he should use to connect to the Earth. The first thing he needs to know is that Earthing products do not operate on electricity, so it does not matter what the electrical current is in his respective country (whether 110 volts or 240 volts, etc). Earthing products simply allow the natural, gentle energy from the Earth outside to be carried inside. When one makes physical—bare skin—contact with the Earthing product it is the same as if he were standing or walking barefoot outside. This is what creates the benefits of Earthing. One preference is that the products throughout the world be connected to Earthing ground rods, however many people like the idea of simply plugging them into an electrical outlet ground port in their home or office. For people who live in tall apartment buildings (high rises), a ground rod may not be feasible, and for people who do not have a grounded electrical system in their home or office, the only option is the ground rod.

The following explanation covers two options for connecting Earthing products. The electrical terms “ground” and “Earth” have the same meaning. In Spanish, the term is “tierra.”

### Option #1: Plug-In

There are many different outlet configurations around the world. Some are grounded (Earthed). Others are not. For this reason, if one wants to plug into a wall outlet he will have to determine first whether his electrical system and outlets are indeed properly grounded. An electrician can determine that for one or he or she can purchase a simple outlet ground checker at an electrical supply or hardware store locally. Outlets with only two holes and no Earth/ground strip or Earth/ground pin or hole means there is no Earth/ground present. One must use a ground rod. This is quite common in older homes. One should keep in mind, however, that an outlet with three holes, or two holes and an Earth/ground strip or Earth/ground pin or hole, does not necessarily mean that the Earth/ground is actually connected. The individual outlet must be tested for correct wiring.

### Option #2

Earthing sleep systems (sheets and recovery bag) come with a 12-inch long ground rod included. The Earthing mats do not include the ground rod. If one wants to use a ground rod for use with a mat, it must be purchased separately. The ground rods are inserted into the ground (dirt, garden bed) outside/below a window or door adjacent to where the Earthing product will be used inside. It is very simple to do. If there is only concrete and no adjacent Earth in which to put the ground rod then this is not an option for him. The Earthing ground rod has a 40 foot (13 meter) cord attached to it. One can run the cord under a window or door, just being careful not to sever the cord. The cord from the Earthing sheet or mat is connected to the ground rod cord, male end into the female end. Again, this is very simple. This is how one sets up the ground rod. The cords that come with each product can be connected to a grounded outlet (or outlet adapter, as described in Option #1) or a ground rod. If additional length is needed, Earthing extension cords can also be purchased. Available also are splitter cords, into which a person can insert the cords from any two Earthing products. The splitter connects either to a wall outlet (or outlet adapter) or to the ground rod cord. All Earthing product connection cords contain a current limiting 100 k resistor.

In electrical engineering, ground or earth may be the reference point in an electrical circuit from which other voltages are measured, or a common return path for electric current, or a direct physical connection to the Earth. Electrical circuits may be connected to ground (earth) for several reasons. In mains powered equipment, exposed metal parts are connected to ground to prevent contact with a dangerous voltage if electrical insulation fails. Connections to ground limit the build-up of static electricity when handling flammable products or when repairing electronic devices. In some telegraph and power transmission circuits, the earth itself can be used as one conductor of the circuit, saving the cost of installing a separate return conductor. For measurement purposes, the Earth serves as a (reasonably) constant potential reference against which other potentials can be measured. An electrical ground system should have an appropriate current-carrying capability in order to serve as an adequate zero-voltage reference level. In electronic circuit theory, a “ground” is usually idealized as an infinite source or sink for charge, which can absorb an unlimited amount of current without changing its potential. Where a real ground connection has a significant resistance, the approximation of zero potential is no longer valid. Stray voltages or earth potential rise effects will occur, which may create noise in signals or if large enough will produce an electric shock hazard. The use of the term ground (or earth) is so common in electrical and electronics applications that circuits in portable electronic devices such as cell phones and media players as well as circuits in vehicles such as ships, aircraft, and spacecraft may be spoken of as having a “ground” connection without any actual connection to the Earth. This is usually a large conductor attached to one side of the power supply (such as the “ground plane” on a printed circuit board) which serves as the common return path for current from many different components in the circuit.

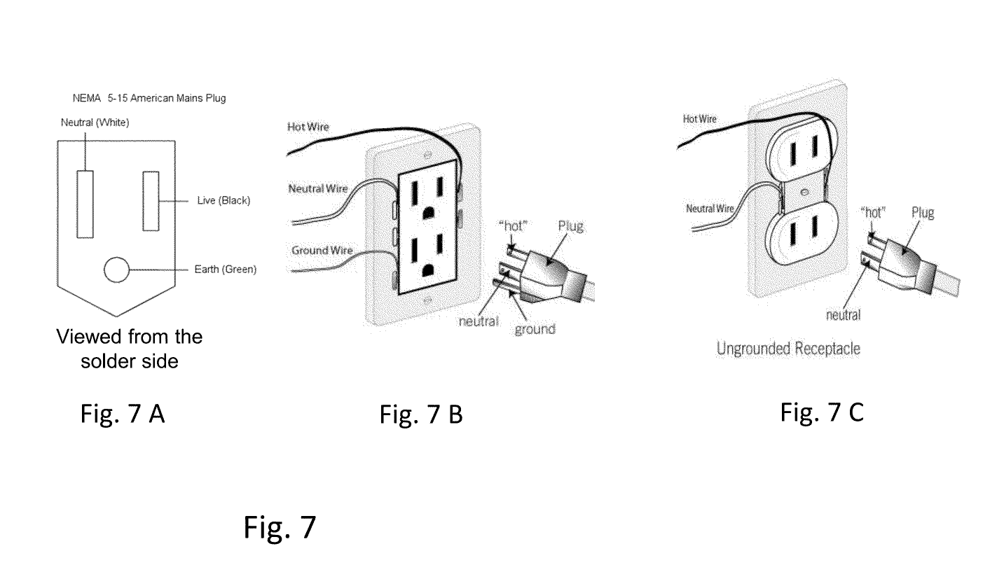

NEMA 5-15/CS22.2, No 42 See FIG. 7 A. The type B mains plug has two flat parallel pins with the same geometry as type A, and a round ground or Earthing pin. It is rated at 15 amperes and 125 volts maximum. The American standard for this connector is known as NEMA 5-15, and the Canadian standard CSA 22.2, No 42. The American and Canadian connectors are effectively identical. The ground pin is longer than the two parallel pins so that the device is grounded before the supply is connected. The neutral insertion point in the type B socket is wider to accommodate polarized type A plugs, but the type B plugs often have both pins narrow, the ground pin enforcing polarity. With American and Canadian plugs, if a person looks directly at a socket, the ground socket will be at a bottom, the live slot is on the right and the neutral slot is on the left. If the plug is polarized, the widest slot is the neutral connector. This view is the same as looking at the solder side or screw side of a re-wirable plug, as shown in the diagram to the left.

Electrical Outlet Problems. The electrical outlet not only provides vital access to the electrical current that makes ones house hum, but it also warrants deeper consideration for reasons of comfort and safety. Inspectors have seen all when it comes to incorrect outlet wiring, safety hazard if left unattended. But before one might discuss safety measures, it is best to start with a quick tour of this component and its mate, the plug.

One may ask or wonder why his electrical outlets have holes of different sizes and shape? See FIG. 7 B. To accommodate the plug is the obvious answer. But there is more to this relationship than meets the eye. Hidden behind the outlet is a series of wires that must be properly connected for the outlet's safe functioning. On a modern electrical outlet that accommodates a three-pronged plug, each hole serves a specific purpose: the round hole is for the ground pin on the plug; the small slot takes the small blade on the plug and connects to the “hot” wire in the outlet (the wire that can cause a shock); the large slot takes the large blade and connects to the “neutral” wire in the outlet. Specific wires have to be connected to the proper terminals for an outlet's safe function. Correct installation is so important that inspectors spot-check outlets with an outlet tester during every inspection.

Reverse Polarity The large slot and small slot on an electrical outlet, and the different-sized blades on a plug, designate their respective polarizations, and ensure that the plug goes in the outlet only one way, safety feature that reduces the chances of shock. For instance, a light-bulb socket has exposed electrical connections, the threads being the most exposed part. But polarized socket threads are attached to the neutral wire to prevent someone from getting a shock when changing a light bulb. If the electrical outlet itself is mis-wired with reverse polarity, the lamp socket threads d scribed above will become “hot”. If one touches the threads in the socket, or on the bulb as one screws it into the socket, one may get a shock.

Outlet Not Grounded. Inspectors have also discovered outlets with the circular ground holes but with no ground wire connected. In older homes, sometimes the cable leading to the outlet does not have a ground wire, yet the outlet has nonetheless been upgraded to a modern grounded type. Some plug-in electrical devices need this ground connection for their built-in safety features. If the outlet appears to be grounded but is not, the device's safety features will not work.

### Old Outlets

In older homes some outlets may have no ground slot at all. This does not represent a defect or safety concern, but a person will not be able to plug in an electrical appliance that has a ground pin on the plug. Today, most plug in appliances are not the grounded style and, therefore, do not use or have a ground pin on the plug because they are a double insulated design. In these cases, the old ungrounded outlet will work fine. If one thinks it might be a good idea to simply cut off the ground pin to accommodate an outlet without a ground hole, he should think again. This procedure is doubly unsafe because it not only bypasses the grounding safety feature, but also it bypasses the polarizing feature since a de-pinned plug can be inserted into the outlet either way. Easy to Fix—An electrician can fix these outlet problems. Though outlets may appear as minor considerations in the grand scheme of the home, ones understanding and the safe installation of ones outlets can prevent serious safety hazards.

If he look around his house, what he will find is that just about every appliance with a metal case has a three-prong outlet. This may also include some things, like his computer, that have a metal-encased power supply inside even if the device itself comes in a plastic case. See FIG. 7 C. The idea behind grounding is to protect the people who use metal-encased appliances from electric shock. The casing is connected directly to the ground prong. If a wire comes loose inside an ungrounded metal case, and the loose wire touches the metal case. If the loose wire is hot, then the metal case is now hot, and anyone who touches it will get a potentially fatal shock. With the case grounded, the electricity from the hot wire flows straight to ground, and this trips the fuse in the fuse box. Now the appliance won't work, but it won't kill him either. What happens if one cuts off the ground prong or use a cheater plug so he can plug a three-prong appliance into a two-prong outlet? Nothing really—the appliance will still operate. What he has done, however, is disable an important safety feature that protects him and others from electric shock if a wire comes loose.

What is claimed is:

1. A personal grounding device to ground a human being with a body and a charged state of electrons, the device is comprised of:
(a) a field or closed grid (like a heating pad) in an encasement to form a mat;
(b) a lead to the field from a ground;
(c) a ground lead (natural or artificial); and
(d) a means for connecting the field grid to the ground
wherein the mat may be placed under a part of the human's body for a period of time to ground the electrical imbalance between the person's body and the earth's natural state of no charge.

2. The device according to claim 1 wherein the closed grid is comprised of materials from the group consisting of copper, aluminum, carbon and a conductive composite material.

3. The device according to claim 1 wherein the encasement is a cover comprised of an inductive-permitting, conductive and non-insulating material.

4. The device according to claim 3 wherein the cover is comprised of materials from the group consisting of cotton cloth, non-insulating plastics, non-insulating vinyl and non-insulating nylon and non-insulating composite material.

5. The device according to claim 1 wherein the means for connecting is an adapter with a receiving end that is comprised of a recessed slot for a short power blade, a recessed slot for a long blade, and an aperture for a long neutral blade, the said recesses and aperture all enclosed by a body and the neutral aperture ending at an opposite engaging end that has a means for connecting to a ground stud.

5. A personal grounding device to ground a human being with a body and a charged state of electrons, the device is comprised of an adapter with a receiving end that is comprised of a recessed slot for a short power blade, a recessed slot for a long blade, and an aperture for a long neutral blade, the said recesses and aperture all enclosed by a body and the neutral aperture ending at an opposite engaging end that has a means for connecting to a ground stud wherein an existing mat with an electrical cord may be placed under a part of the human's body for a period of time to ground the electrical imbalance between the person's body and the earth's natural state of no charge and the cord may be connected to an electrical neutral with the adapter.
